(19) United States
(12) Patent Application Publication
(10) Pub. No.: US 2026/0066691 A1
(43) Pub. Date: Mar. 5, 2026

(54) BATTERY BACK-UP SYSTEM FOR HYDRAULIC ELEVATORS

(71) Applicant: Reynolds & Reynolds Electronics, Inc., Bethlehem, PA (US)

(72) Inventors: Brian Reidy, Bethlehm, PA (US); Werner John Reinartz, Coopersburg, PA (US)

(73) Assignee: Reynolds & Reynolds Electronics, Inc., Bethlehem, PA (US)

(21) Appl. No.: 19/314,985

(22) Filed: Aug. 29, 2025

Related U.S. Application Data
(60) Provisional application No. 63/689,914, filed on Sep. 3, 2024.

(51) Int. Cl. H02J 9/06; H02J 7/00; H02J 7/02

(52) U.S. Cl. CPC H02J 9/062; H02J 7/02; H02J 7/50; H02J 7/855; H02J 9/068; H02J 2105/12; H02J 2207/20; H02J 2207/50

(57) ABSTRACT

A battery back-up system for hydraulic elevator having a battery charger circuit configured to receive AC power from a main power supply at a supply voltage, at least one battery operatively connected to the battery charger circuit, and one or more processors operatively connected to the at least one battery. The battery charger circuit is configured to selectively supply DC power to the at least one battery at a charger voltage, the charger voltage being less than the supply voltage. Upon determining a malfunction of the main power supply, the at least one battery is configured to be electrically connected to a elevator control system and hydraulic elevator.

### CROSS-REFERENCE TO RELATED APPLICATIONS

This application claims the benefit of U.S. Provisional Application No. 63/689,914, filed Sep. 3, 2024, which is herein incorporated by reference in its entirety as if fully set forth.

### TECHNICAL FIELD

The present invention relates to a battery back-up system for hydraulic elevators and, more particularly, to a microprocessor controlled battery back-up system having a battery charger circuit and at least one battery in operative communication with a main power supply and hydraulic elevator.

### BACKGROUND OF THE INVENTION

Previous battery back-up power sources for operating hydraulic elevators in emergency situations have relied on a simple algorithm that resulted in crude and inefficient power generation. Modern elevator controllers and door operators have become more sensitive to the power line quality and often require a pure sinewave power source. Additionally, elevator manufacturers prefer battery back-up power sources that are compact in size, low cost, and configured for quick and easy installation.

Existing battery back-up systems typically use a transformer to step down voltage from the incoming AC power supply (often 120, 220, or 480V) to a voltage suitable for charging batteries (often 48V). Transformers are undesirable because they are heavy and bulky. In addition, elevators may operate using different the input voltages. This requires either (a) a different battery back-up model to be manufactured for each different input voltage or (b) the uses of an even heavier/bulkier transformer with multiple windings. Accordingly, a need exists for a battery back-up system for elevators that is compact, lightweight, and can accommodate multiple input voltages.

### SUMMARY OF THE INVENTION

The needs remaining in the prior art are addressed by the present invention, which relates to a battery back-up system for hydraulic elevators. In particular, according to at least one aspect of the present invention, the battery back-up system eliminates the need for using a transformer (as found in prior art arrangements), which significantly decreases the size and complexity of the arrangement. Moreover, advanced integrated circuitry technology is employed that allows for a surface-mount arrangement of the integrated circuits to be used in a compact assembly.

In accordance with the principles of the present invention, a battery back-up system for hydraulic elevator is disclosed. The battery back-up system may include a battery charger circuit configured to receive AC power from a main power supply at a supply voltage, at least one battery operatively connected to the battery charger circuit, and processor operatively connected to the at least one battery. The battery charger circuit may be configured to selectively supply DC power to the at least one battery at a charger voltage where the charger voltage may be less than the supply voltage. The battery may be configured to receive reduced and converted power from the battery charger circuit. The processor may be configured to communicate with an elevator control system. The processor may be configured to determine a power malfunction from the main power supply. The processor, upon determining a malfunction of the main power supply, may be configured to electrically connect the at least one battery to the elevator control system and the hydraulic elevator.

In accordance with principles of the present invention, the battery back-up system may include a high voltage DC bus inverter and a sinewave generator, wherein the bus inverter and the sinewave generator may be configured to convert discharge power of the at least one battery into AC power suitable for the elevator control system and the hydraulic elevator. The processor may be configured to generate pulse-width modulated output signals, wherein the pulse-width modulated output signals may be configured to turn on the high voltage DC bus inverter and the sinewave generator. The at least one battery may comprise a plurality of batteries in a series connection. The battery back-up system may include a relay. Power from the main power supply may first pass through the relay of the battery back-up system and subsequently pass to the elevator control system and the hydraulic elevator.

In accordance with principles of the present invention, the battery charger circuit may include a full-wave rectifier, one or more voltage divider, and a voltage controlled switch. The full-wave rectifier may be configured to receive power from the main power supply in AC form and may be configured to convert the power from AC to DC. One or more voltage divider may be configured to decrease voltage of the received power. The voltage-controlled switch may be configured to receive power from the one or more voltage divider. Upon receiving power at a certain voltage level, the voltage-controlled switch may be configured to activate a high-side gate driver via an optocoupler. The battery charger circuit may include a high-side gate driver and a N-channel MOSFET operatively connected to the high-side gate driver. When the high-side gate driver is activated by an optocoupler the N-channel MOSFET may be configured to receive power from a full-wave rectifier. The N-channel MOSFET may be configured to charge a capacitor. The high-side gate driver may be operatively connected to an independent power source.

In accordance with principles of the present invention, the battery charger circuit may include a switch mode power supply device. The switch mode power supply device may receive power from a capacitor charged by a N-channel MOSFET. The switch mode power supply device may be in a SEPIC configuration, thereby allowing received power to be regulated to a desired voltage. The desired voltage may be lower than the received power from the main power supply and in DC form. The switch mode power supply device may be operatively connected to an independent power source. The battery charging circuit may provide a desired voltage from a switch mode power supply device to the battery.

In accordance with principles of the present invention, the processor may be one or more microprocessors. The processor may be configured to actuate a relay, thereby disconnecting the elevator control system from the main power supply. The processor may be configured to generate an emergency signal. The processor may be configured to transmit the emergency signal to the elevator control system.

In accordance with principles of the present invention, the power malfunction may be any fluctuation in power supplied by the main power supply to the hydraulic elevator. The elevator control system, upon receiving the emergency signal, may be configured to lower the one or more hydraulic elevator to a lower level and open a door of the hydraulic elevator, thereby allowing egress of passengers in the hydraulic elevator. The control panel may be configured to implement self-checks of the battery.

In accordance with principles of the present invention, a hydraulic elevator system may include the battery back-up system, hydraulic elevator, a main power supply operatively connected to the hydraulic elevator, and an elevator control system operatively connected to the battery back-up system, the main power supply, and the hydraulic elevator.

Other and further embodiments and aspects of the present invention will become apparent during the course of the following discussion and by reference to the accompanying drawings.

### BRIEF DESCRIPTION OF DRAWINGS

Referring now to the drawings, where the like numerals represent like parts:

FIG. 1 is a block diagram of an overall battery back-up system for one or more hydraulic systems according to a non-limiting embodiment of the present invention; and

FIG. 2 is a block diagram of a battery charger circuit of FIG. 1 according to a non-limiting embodiment of the present invention.

### DETAILED DESCRIPTION OF THE INVENTION

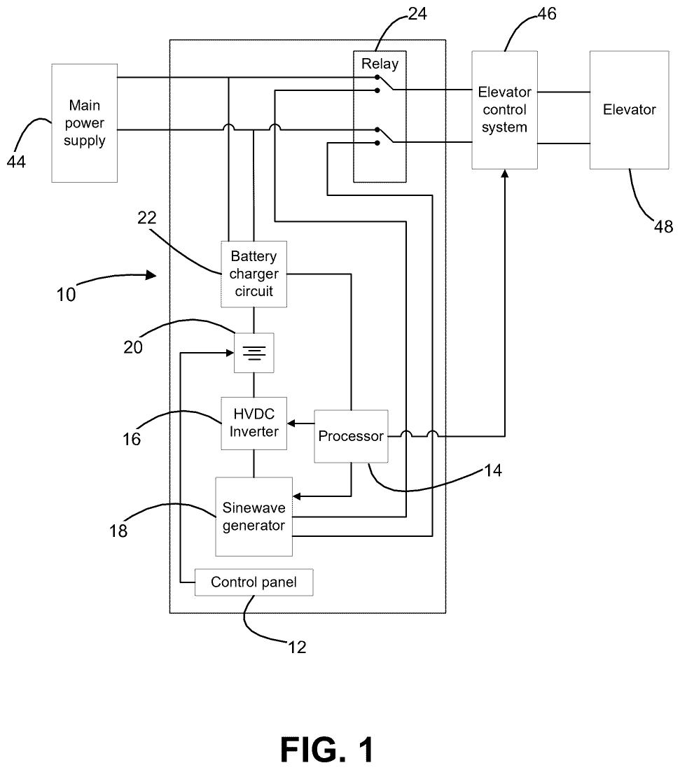

FIG. 1 is a block diagram showing an exemplary implementation of a battery back-up system 10 for a hydraulic elevator 48. The battery back-up system 10 may be operatively connected to an elevator control system 46 and a main power supply 44. The battery back-up system may include a control panel 12, a processor 14, a high voltage DC bus inverter 16, a sinewave generator 18, a battery bank 20, a battery charger circuit 22, and a relay 24. In other exemplary implementations, the elevator control system 46 and the battery back-up system 10 could be adapted to control more than one hydraulic elevator.

With continued reference to FIG. 1, the voltage provided by the main power supply 44 may be anywhere between 120-480 VAC. For example, the voltage may be 120 VAC, 208 VAC, 240 VAC, or 480 VAC. The elevator control system 46 may be configured to receive power from the main power supply 44. The elevator control system 46 may receive power from the main power supply 44 via a relay 24 of the battery back-up system 10. One or more hydraulic elevators 48 may be configured to receive power from the main power supply 44. The hydraulic elevator 48 may receive power from the main power supply 44 via a relay 24 of the battery back-up system 10. In another non-limiting aspect of the invention, the hydraulic elevator 48 may receive power from the main power supply 44 via the relay 24 and the elevator control system 46.

The processor 14 of the battery back-up system 10 may be configured to communicate with the high voltage DC bus inverter 16, the sinewave generator 18, the elevator control system 46, and battery charger circuit 22. The processor 14 may be operatively connected to the high voltage DC bus inverter 16, the sinewave generator 18, the elevator control system 46, and the battery charger circuit 22. In other implementations more than one processor could be provided. The control panel 12 may be configured to communicate with the battery bank 20. The control panel 12 may be operatively connected to the battery bank 20. The control panel 12 may be configured to implement self-checks of the battery bank 20 to ensure the functionality of the battery bank 20.

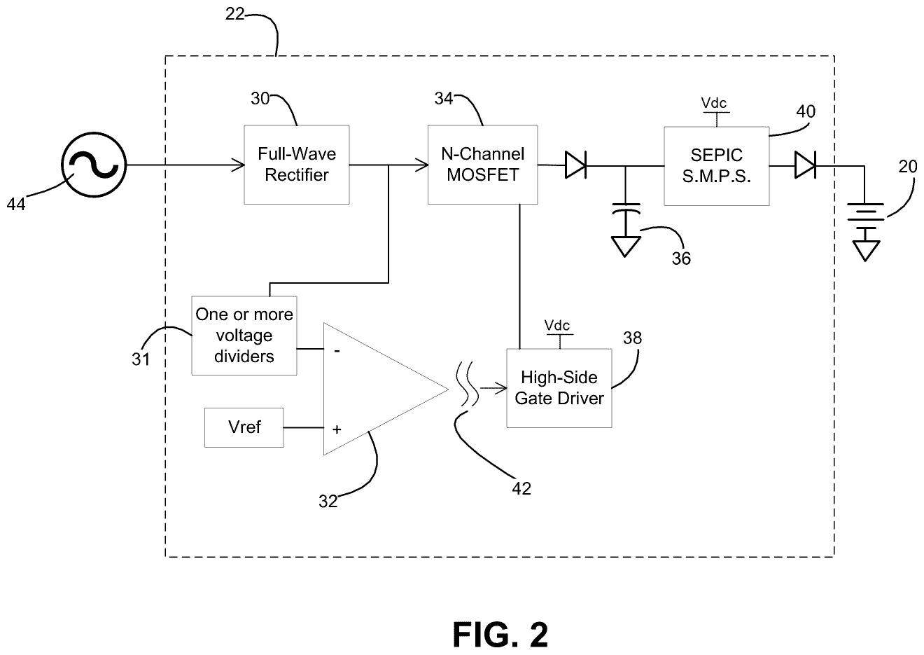

With continued reference to FIG. 1, the battery charger circuit 22 of the battery back-up system 10 may be configured to receive power from the main power supply 44. As discussed more in detail with respect to FIG. 2, the battery charger circuit 22 may be configured to convert the received voltage from the main power supply 44 into suitable voltage for the battery bank 20. The battery charger circuit 22 may be configured to send voltage to the battery bank 20. The battery bank 20 may be configured to receive power from the battery charger circuit 22. The battery bank 20 may be configured to send power to a high voltage DC bus inverter 16. The high voltage DC bus inverter 16 may be configured to send power to the sinewave generator 18. The sinewave generator 18 may be configured to send power to the relay 24. The relay 24 may be configured to send received power from the sinewave generator 18 to the elevator control system 46 and the hydraulic elevator 48. The elevator control system 46 may be configured to send power to the hydraulic elevator 48.

In battery back-up system 10, the battery bank 20 is comprised of four batteries arranged in series, having a total nominal voltage of 48 VDC. In other implementations, a different number of batteries could be provided and/or some or all of the batteries could be connected in parallel. The battery back-up system 10 is adapted to supply as DC power to the battery bank 20 at a voltage that matches the total nominal voltage of the battery bank 20. For example, the battery bank 20 may receive a voltage of 48 VDC or 54 VDC from the battery charger circuit 22. In most implementations, the DC voltage supplied to the battery bank 20 will be lower than the AC voltage of the main power supply 44.

With continued reference to FIG. 1 and FIG. 2, the battery charger circuit 22 may be configured to step down the AC power received from the main power supply 44 to a voltage suitable for the battery bank 20 and to convert the power to DC. Referring to FIG. 2, the battery charger circuit 22 may include a full-wave rectifier 30, a voltage-controlled switch 32, a N-channel MOSFET 34, a high-side gate driver 38, a capacitor 36, and a switch mode power supply device 40 that may be in a single-ended primary-inductor converter (“SEPIC”) configuration.

The full-wave rectifier 30 may be configured to receive AC power from the main power supply 44 in AC. The full-wave rectifier 30 may be configured to convert the received power from AC to DC. The full-wave rectifier 30 may be configured to send the converted power to one or more voltage dividers 31. The one or more voltage dividers 31 may be configured to decrease the voltage level of the rectified signals generated by the full-wave rectifier 30. The decreased voltage may be used to monitor the power flow from the main power supply 44. The decreased voltage may be compared to a pre-determined reference voltage. A capacitor may be used in conjunction with the one or more voltage dividers 31 to monitor the voltage from the main power supply 44. The one or more voltage dividers 31 may be configured to send the lowered power to the voltage-controlled switch 32. Once the voltage-controlled switch 32 receives a power at a certain voltage level, such as a pre-determined reference voltage, the voltage-controlled switch 32 may be turned on and activate an optocoupler 42. The optocoupler, once activated, may emit a signal that may be received by the high-side gate driver 38. The voltage-controlled switch 32 and the high-side gate driver 38 may be electrically isolated, and the high-side gate driver 38 may be powered by a separate power source, such as a 15 VDC battery. Once the high-side gate driver 38 receives a signal from the optocoupler, the high-side gate driver 38 may be activated.

The N-channel MOSFET 34 may be operatively connected to the high-side gate driver 38. Once the high-side gate driver 38 is activated, the N-channel MOSFET 34 may be configured to receive power from the full-wave rectifier 30. The N-channel MOSFET 34 may be configured to charge a capacitor 36 with the received power. The capacitor 36 may be charged until a pre-determined threshold is met. After the threshold is met, the high-side gate driver 38 may be grounded, which stops power flow from an independent power source (not shown) to the N-Channel MOSFET, which prevents the capacitor from being charged further. This chopped voltage waveform is sent to the switch mode power supply device 40.

The switch mode power supply device 40 may be in a SEPIC configuration, thereby allowing received power, which may vary, to be regulated to a desired voltage, or a charger voltage. For example, the desired voltage may be suitable for the battery bank 20, such as 48 VDC, 54 VDC, etc. The desired voltage of the battery bank 20 may be less than the voltage received from the main power supply 44 and in DC form. The switch mode power supply device 40 may be operatively connected to an independent power source, such as a 15 VDC battery. The switch mode power supply device 40 may be configured to send the regulated power at a desired voltage to the battery bank 20. The switch mode power supply device 40 may be configured to monitor the current received and is configured to stop receiving current on a cycle-by-cycle basis if the current is too high, thereby limiting the amount of power output to the battery bank 20. For example, the switch mode power supply device 40 may experience a high load when the output voltage is greater than the voltage of the battery bank 20.

With reference to FIG. 1, the battery bank 20 may be configured to provide power in DC form to the high voltage DC bus inverter 16. The high voltage DC bus inverter 16 may be configured to provide power to the sinewave generator 18. The high voltage DC bus inverter 16 and the sinewave generator 18 may be configured to convert the discharged power from the battery bank 20 into suitable AC power for the elevator control system 46 and the hydraulic elevator 48. The processor 14 may be configured to generate pulse-width modulated output signals. The pulse-width modulated output signals may be transmitted from the processor 14 to the high voltage DC bus inverter 16 and the sinewave generator 18 to activate the high voltage DC bus inverter 16 and the sinewave generator 18.

The processor 14 may be configured to detect a power malfunction from the main power supply 44. The power malfunction could be any fluctuation in the flow of power to the elevator control system 46 or the hydraulic elevator 48. For example, the fluctuation in the flow of power may be any voltage fluctuation, frequency variation, phase fluctuation, harmonic distortion, etc. for any duration of time that deviates from a pre-determined acceptable flow of power from the main power supply 44. Upon determining a malfunction, the processor 14 may be configured to electrically connect the battery bank 20 to the elevator control system 46 and/or the hydraulic elevator 48.

The processor 14 may determine that there is such malfunction in the power supply. For example, the processor 14 may determine that there is a malfunction when it senses that the voltage has disappeared from input terminals of the main power supply 44. The one or more voltage dividers 31 and one or more capacitors (not shown) that receive power from the full-wave rectifier 30 may monitor the voltage present after the full wave rectifier 30. When voltage drops below a threshold, such as a pre-determined reference voltage, the processor 14 may determine that line power has been lost and determines to run a rescue sequence. The processor 14 may be operatively connected to or in communication with the one or more voltage dividers 31 and/or the capacitor following the full-wave rectifier 30 of the battery charger circuit 22. After the processor 14 has determined to run a rescue sequence, relay 24 may be change its state in order to disconnect the elevator control system 46 from the main power supply 44. The changed state of the relay 24 may allow backup power from the sinewave generator 18 to power the elevator control system 46 and the hydraulic elevator 48. After determining that there is a malfunction and determining to run the rescue sequence, the processor 14 may be configured to generate an emergency signal and transmit the emergency signal to the elevator control system 46. After receiving the emergency signal, the elevator control system 46 may be configured to lower the hydraulic elevator 48 to a lower level from its initial location when receiving the one or more signals and open the door of the hydraulic elevator 48, thereby allowing egress of passengers in the hydraulic elevator 48.

The simplicity of the disclosed battery back-up system 10 design makes it unique from other emergency battery systems. For example, the disclosed battery charger circuit 22 enables modification of the power from the main power supply 44 without the need to use a step-down transformer. The replacement of the transformer provides an improvement in terms of size and cost compared to conventional battery arrangements. This may allow the battery back-up system 10 to be small enough to be installed inside pre-existing electrical equipment cabinets and yet be able to power hydraulic elevator to lower the elevator and open the door of the elevator. Additionally, the disclosed battery back-up system 10 design ensures extended usable life of the battery bank 20 while also ensuring that they are sufficiently charged and ready for use in the event of a power malfunction.

While the invention has been described with reference to specific embodiments, various changes may be made and equivalents may be substituted for elements thereof by those skilled in the art without departing from the scope of the invention. In addition, other modifications may be made to adapt a particular situation or method to the teachings of the invention without departing from the essential scope thereof.

1. A battery back-up system for hydraulic elevator, the battery back-up system comprising:
a battery charger circuit configured to receive AC power from a main power supply at a supply voltage;
at least one battery operatively connected to the battery charger circuit; and
one or more processors operatively connected to the at least one battery,
wherein the battery charger circuit is configured to selectively supply DC power to the at least one battery at a charger voltage, the charger voltage being less than the supply voltage,
wherein the at least one battery is configured to receive reduced and converted power from the battery charger circuit,
wherein the one or more processors is configured to communicate with an elevator control system,
wherein the one or more processors is configured to determine a power malfunction from the main power supply, and
wherein the one or more processors, upon determining a malfunction of the main power supply, is configured to electrically connect the at least one battery to the elevator control system and the hydraulic elevator.

2. The battery back-up system of claim 1, further comprising:
a high voltage DC bus inverter; and
a sinewave generator,
wherein the high voltage DC bus inverter and the sinewave generator are configured to convert discharge power of the at least one battery into AC power suitable for the elevator control system and the hydraulic elevator.

3. The battery back-up system of claim 2, wherein the one or more processors is configured to generate pulse-width modulated output signals, wherein the pulse-width modulated output signals are configured to turn on the high voltage DC bus inverter and the sinewave generator.

4. The battery back-up system of claim 1, wherein the at least one battery comprises a plurality of batteries in a series connection.

5. The battery back-up system of claim 1 further comprising:
a relay, wherein power from the main power supply first passes through the relay of the battery back-up system and subsequently passes to the elevator control system and the hydraulic elevator.

6. The battery back-up system of claim 1, wherein the battery charger circuit further comprises:
a full-wave rectifier, wherein the full-wave rectifier is configured to receive power from the main power supply in AC form and is configured to convert the power from AC to DC;
one or more voltage divider configured to decrease voltage of the received power from the main power supply; and
a voltage-controlled switch configured to receive power from the one or more voltage divider,
wherein, upon receiving power at a certain voltage level, the voltage-controlled switch is configured to activate a high-side gate driver via an optocoupler.

7. The battery back-up system of claim 1, wherein the battery charger circuit further comprises:
a high-side gate driver; and
a N-channel MOSFET operatively connected to the high-side gate driver,
wherein when the high-side gate driver is activated by a optocoupler the N-channel MOSFET is configured to receive power from a full-wave rectifier,
wherein the N-channel MOSFET is configured to charge a capacitor, and
wherein the high-side gate driver is operatively connected to an independent power source.

8. The battery back-up system of claim 1, wherein the battery charger circuit further comprises:
a switch mode power supply device,
wherein the switch mode power supply device receives power from a capacitor charged by a N-channel MOSFET,
wherein the switch mode power supply device is in a SEPIC configuration, thereby allowing received power to be regulated to a desired voltage,
wherein the desired voltage is lower than the received power from the main power supply and in DC form, and
wherein the switch mode power supply device is operatively connected to an independent power source.

9. The battery back-up system of claim 1, wherein the battery charger circuit provides a desired voltage from a switch mode power supply device to the at least one battery.

10. The battery back-up system of claim 1, wherein the one or more processors is one or more microprocessors.

11. The battery back-up system of claim 1, wherein the one or more processors is configured to actuate a relay, thereby disconnecting the elevator control system from the main power supply.

12. The battery back-up system of claim 1, wherein the one or more processors is configured to generate an emergency signal, and wherein the one or more processors is configured to transmit the emergency signal to the elevator control system.

13. The battery back-up system of claim 1, wherein the power malfunction comprises any fluctuation in power supplied by the main power supply to the hydraulic elevator.

14. The battery back-up system of claim 12, wherein the elevator control system, upon receiving the emergency signal, is configured to lower the one or more hydraulic elevator to a lower level and open a door of the hydraulic elevator, thereby allowing egress of passengers in the hydraulic elevator.

15. The battery back-up system of claim 1 further comprising:
a control panel configured to implement self-checks of the battery.

16. A hydraulic elevator system comprising:
the battery back-up system of claim 1;
hydraulic elevator;
a main power supply operatively connected to the hydraulic elevator; and
an elevator control system operatively connected to the battery back-up system, the main power supply, and the hydraulic elevator.
